(19) United States
(12) Patent Application Publication
(10) Pub. No.: US 2019/0077329 A1
(43) Pub. Date: Mar. 14, 2019

(54) Trailer Hitch Extension and Cargo Carrier Assembly

(71) Applicant: Terrence Sablatura, Columbus, TX (US)

(72) Inventor: Terrence Sablatura, Columbus, TX (US)

(21) Appl. No.: 16/016,090

(22) Filed: Jun. 22, 2018

Related U.S. Application Data
(60) Provisional application No. 62/556,625, filed on Sep. 11, 2017.

(51) Int. Cl. B60R 9/06

(52) U.S. Cl. CPC B60R 9/06

(57) ABSTRACT

A high profile trailer hitch extension and cargo carrier assembly comprising a hitch receiver extension and a cargo carrier. The hitch receiver extension comprises a first beam, a second beam, a third beam, a receiving member, a first pin hole, a second pin hole, a first pin, and a second pin. The first beam has a first end, a second end, and the first pin hole is located on a side surface proximate the first end. The second beam has a first end, a second end, and the first end of the second beam is attached to the second end of the first beam. The second beam is angled upwards from the first beam. The third beam has a first end and a second end, and said first end is connected to the first beam and the second end is connected to the second beam. The receiving member is connected to the second end of the second beam and has an interior receiving volume, and the second pin hole is located on a side surface of the receiving volume. The cargo carrier has a mounting flange and a cargo area. The mounting flange can be inserted into the receiving volume of the receiving member and secured by inserting the second pin through the second pin hole of the hitch receiver extension and a corresponding pin hole in the mounting flange.

### CROSS-REFERENCES TO RELATED APPLICATIONS

This application claims priority to provisional application No. 62/556,625 filed Sep. 11, 2017, the contents of which are incorporated by reference herein.

### STATEMENT REGARDING FEDERALLY SPONSORED RESEARCH OR DEVELOPMENT

Not applicable.

### BACKGROUND OF THE INVENTION

### 1. Field of the Invention

A trailer hitch is a device mounted to or integral the chassis of a vehicle. Trailer hitches act as a receiving point for connecting trailers and other equipment to a vehicle, and are generally located at the rear or front of a vehicle. Trailer hitches are found on automobiles, golf carts, all-terrain vehicles, four wheelers, tractors, snow mobiles and other types of vehicles.

A receiver hitch is a trailer hitch with a receiving volume. Square two-inch receiving hitches are standard in commercially available vehicles. For a traditional towing setup, a ball mount is inserted into and secured within the two-inch receiver and a trailer is attached to the ball mount.

In addition to ball mounts, there are voluminous products and equipment designed to attach to a two-inch receiver. For example, basic vertical extensions are available allowing the user to manipulate the location of the two-inch receiver. There are also a variety of commercially available cargo carriers designed to attach to a two-inch receiver. Hitch based cargo carriers allow for exterior storage space without sacrificing any storage or passenger space inside the vehicle.

A problem with existing hitch based cargo carriers is that the cargo carrier impedes the opening and closing of the rear vehicle door. A user must completely remove or disassemble the hitch based cargo carrier in order to access the rear of the vehicle. In some types of vehicles, the two-inch receiver is located too low on the vehicle and too close to ground level, making it impossible to attach a cargo carrier without the cargo carrier striking the ground when the vehicle travels over uneven terrain.

### SUMMARY OF THE INVENTION

The present invention is a high profile trailer hitch extension and cargo carrier assembly that allows the user to access and utilize the cargo carrier while simultaneously accessing the rear of the vehicle via the rear door. The invention also generally provides a higher horizontal plane for the bottom of the carrier, allowing for more convenient access to cargo mounted to a trailer hitch and increased ground clearance. The invention is designed to be used with any type of vehicle with a two-inch receiver, including but not limited to, automobiles and all-terrain-vehicles.

The invention comprises a dual angle two-inch receiver extension and a detachable cargo carrier. The dual angle receiver extension re-locates the two-inch receiving volume to an ideal height and distance away from the vehicle. This ideal height and distance is calculated so that the extension assembly can be used with any type of vehicle without interfering with the rear door.

### BRIEF SUMMARY OF THE DRAWINGS

FIG. 1 is a perspective view of the hitch receiver extension and cargo carrier.

FIG. 2 is a perspective view of the hitch receiver extension.

FIG. 3 is a side view of the hitch receiver extension.

FIG. 4 is a side view of the cargo carrier.

FIG. 5 is a bottom perspective view of the cargo carrier.

### DETAILED DESCRIPTION

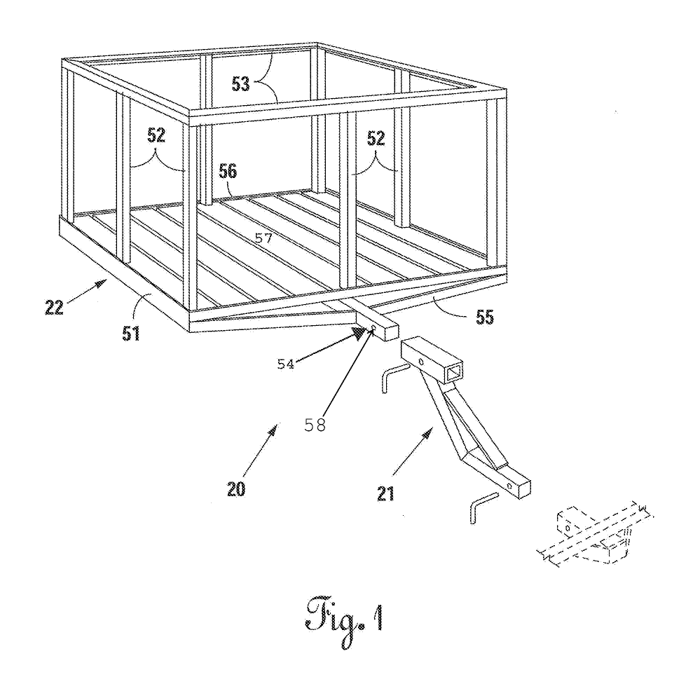

The structure of a first embodiment 20 of the hitch extension and cargo carrier assembly is described with reference to FIGS. 1-3 and comprises a hitch extension 21 and a carrier 22.

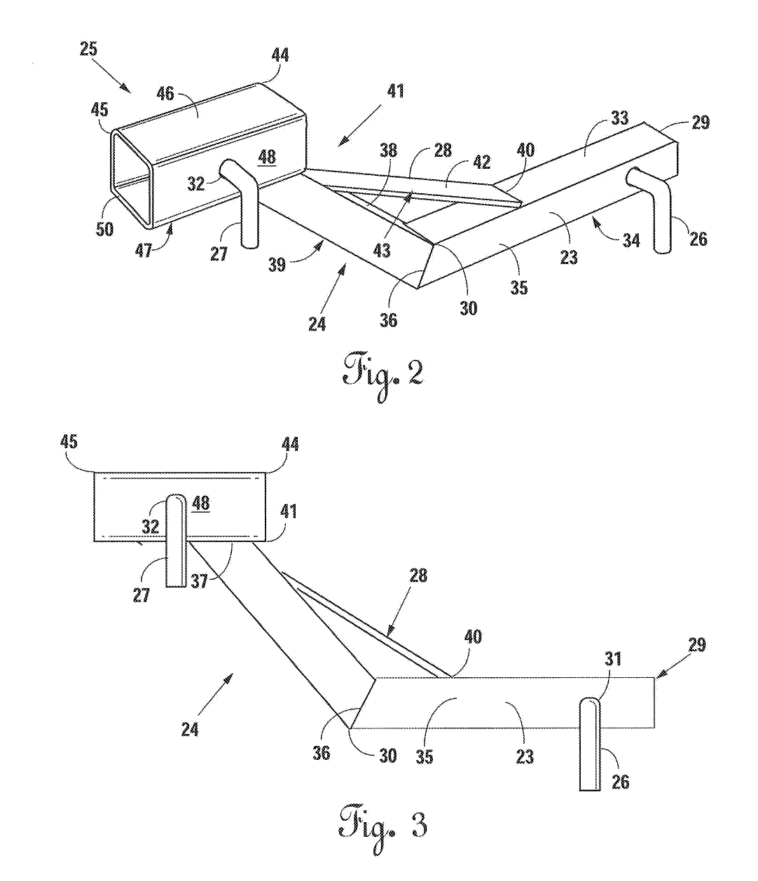

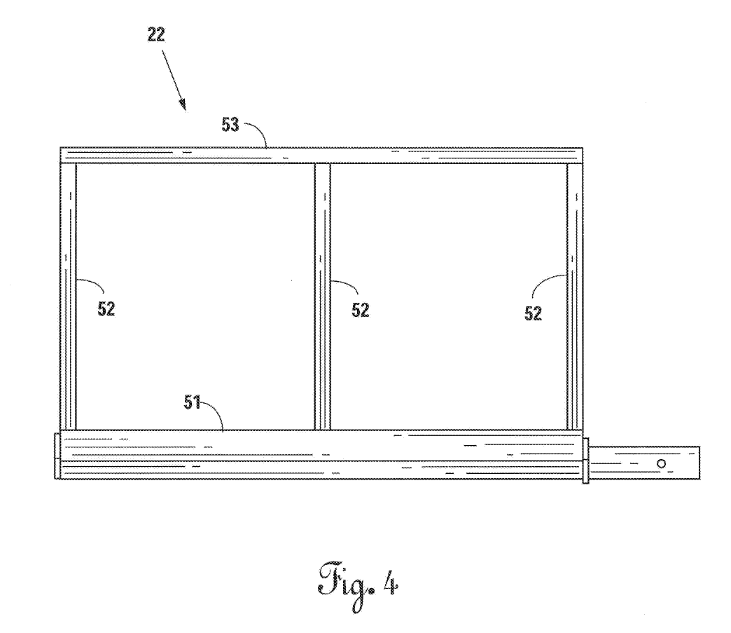

Referring to FIG. 2-3, the hitch extension 21 comprises a first beam 23, a second beam 24, a third beam 28, a receiving member 25, a first pin 26, and a second pin 27.

The first beam 23 has a first end 29, a second end 30, a top surface 33, a bottom surface 34, and two side surfaces 35. In this embodiment, the first beam 23 is a square prism. The first beam 23 has at least one first pin hole 31 through the side surface 35. Ideally, the diameter of the first pin hole 31 is 25/64 inches. The pin hole 31 is proximate the first end 29 of the first beam 23. The exterior width of the first end 29 of the first beam 23 is slightly smaller than the interior width of a standard two-inch hitch receiver, allowing the first end 29 of the first beam to slide into a standard two-inch hitch receiver. The first beam 23 can be secured to the two-inch receiver of a vehicle by inserting the first pin 26 through a hole in the vehicle's two-inch receiver and the first pin hole 31 of the hitch extension 21. Ideally, the diameter of the pin 26 is ⅜ inches. When the hitch extension 21 is attached to a vehicle, the horizontal plane of the first beam 23 is generally parallel to the horizontal plane of the two-inch receiver. The length of the bottom surface 34 of the first beam 23 is 11.86 inches. The length of the top surface 33 of the first beam 23 is 10.98 inches. The first beam 23 has a central axis.

The second beam 24 has a first end 36, a second end 37, a top surface 38, and a bottom surface 39. The first end 36 of the second beam is welded to the second end 30 of the first beam 23. The second beam 24 is a square prism with an exterior width equal to the exterior width of the first beam 23. The second beam 24 is angled upwards relative to the horizontal plane of the first beam 23. The angle between the top surface 33 of the first beam 23 and the top surface 38 of the second beam 24 is one-hundred-thirty-three degrees. The length of the bottom surface 39 of the second beam 24 is 9.84 inches. The length of the top surface 38 of the second beam 24 is 7.16 inches. The second beam has a central axis.

The third beam 28 has a first end 40, a second end 41, a top surface 42, and a bottom surface 43. The third beam 28 is a flat rectangular prism. The first end 40 of the third beam 28 is welded to the top surface 33 of the first beam 23. The first end 40 of the third beam 28 is located 7.68 inches from the first end 29 of the first beam 23. The second end 41 of the third beam 28 is welded to the top surface 38 of the second beam 24. The second end 41 of the third beam 28 is located 1.77 inches from the second end 37 of the second beam 24. The third beam 28 is 7.98 inches in length. The angle between the top surface 33 of the first beam 23 and the top surface 42 of the third beam 28 is one-hundred-fifty degrees.

The receiving member 25 has a first end 44, a second end 45, a top surface 46, a bottom surface 47, two side surfaces 48, at least one pin hole 32, and a receiving volume 50. The bottom surface 47 of the receiving member 25 is welded to the second end 37 of the second beam 24. The connection between the second beam 24 and the receiving member 25 is 2.95 inches from the second end 45 of the receiver 25. The horizontal plane of the receiving member 25 is parallel to the horizontal plane of the first beam 23. The interior of the receiving member 25 is a receiving volume 50. The width of the receiving volume 50 is two inches, and is ideally the same size as a standard two-inch hitch receiver. The pin hole 32 is located in a side surface 48. The diameter of pin hole 32 is 25/64 inches. The diameter of the second pin 27 is ⅜ inches. The center of the pin hole 32 is 2.87 inches from the second end 45 of the receiving member 25.

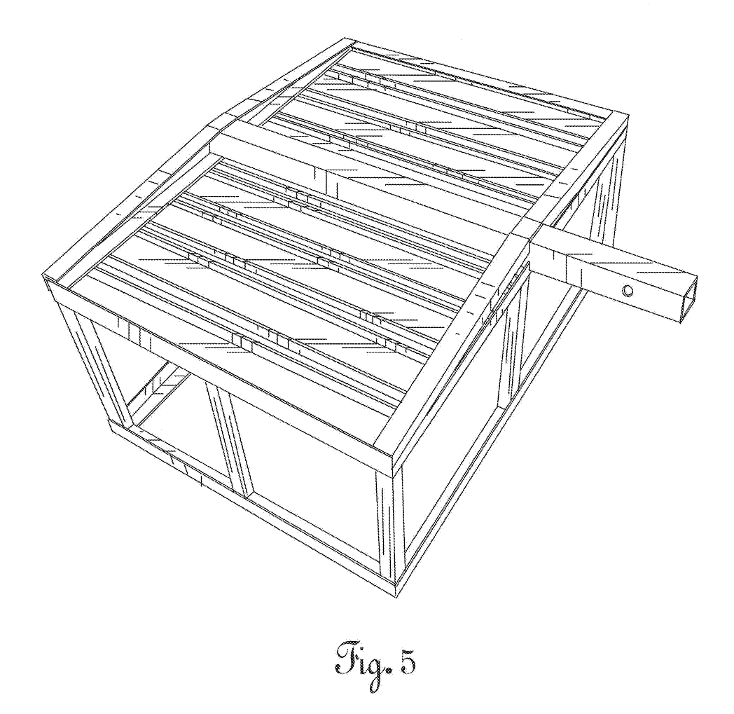

Referring to FIGS. 1, 4, and 5, the carrier 22 is made out of aluminum and has a base 51, vertical beams 52, a rim 53, a bottom surface 57, and a mounting flange 54. The base 51 has a first end 55 and a second end 56. The mounting flange 54 is centrally located on the first end 55 of the base. The mounting flange has pin hole 58. The diameter of pin hole 58 is 25/64 inches. The base 51 is a rectangle. Vertical beams 52 extend upward and perpendicularly from the surface 57 of the base 51. The rim 53 is attached to the ends of the vertical beams 52 opposite the base 51. The number of beams 52 can vary depending on the intended use of the carrier.

The function of the embodiment 20 of the hitch extension and cargo carrier assembly is described with reference to FIG. 1-3. The hitch extension 21 is attached to a vehicle as follows. The first end 29 of the first beam 23 of the hitch extension 21 is inserted into the two-inch hitch receiver of a vehicle. The hitch extension 21 is secured to the vehicle by inserting the first pin 26 through a pin hole located on the vehicle's hitch receiver and through the pin hole 31 in the first beam 23 of the hitch extension 21.

The cargo carrier 22 is attached to the hitch extension 21 as follows. The mounting flange 54 of the cargo carrier 22 is inserted through the second end 45 of the receiving member 25 of the hitch extension 21 and into the receiving volume 50. The mounting flange 54 slides into, and nests within, the receiving volume 50 of the receiving member 25. The carrier 22 is secured to the hitch extension 21 by inserting the second pin 27 through the pin hole 32 in the receiver 25 and through the pin hole 58 in the mounting flange 54.

The embodiment 20 has been described with references to particular dimensions and materials. One skilled in the art understands that other suitable materials and dimensions could be used to practice the disclosed invention.

I claim:

1. A hitch cargo carrier assembly comprising:
a hitch receiver extension and a cargo carrier.

2. A hitch receiver extension assembly comprising:
a first beam, a second beam, a third beam, a receiving member, a first pin hole, a second pin hole, a first pin, and a second pin;
wherein said first beam has a first end, a second end, a top surface, a bottom surface, and two side surfaces, and said first pin hole is located on a side surface proximate the first end;
wherein the second beam has a first end, a second end, a top surface, and a bottom surface, and the first end of the second beam is connected to the second end of the first beam;
wherein said second beam is angled upwards from the first beam;
wherein said third beam has a first end and a second end, and said first end is connected to the top surface of the first beam and the second end is connected to the top surface of the second beam;
wherein the receiving member has a first end, a second end, a top surface, two side surfaces, and an interior receiving volume;
wherein the bottom surface of the receiving member is connected to the second end of the second beam;
wherein the second pin hole is located on a side surface of the receiving member.

3. The hitch cargo carrier assembly of claim 1 wherein:
the cargo carrier comprises a mounting flange, a base, vertical beams; horizontal beams, and a collar.

4. The hitch cargo carrier assembly of claim 1 wherein:
the hitch receiver extension comprises a first beam, a second beam, a third beam, a receiving member, a first pin hole, a second pin hole, a first pin, and a second pin;
wherein said first beam has a first end, a second end, a top surface, a bottom surface, and two side surfaces, and said first pin hole is located on a side surface proximate the first end;
wherein the second beam has a first end, a second end, a top surface, and a bottom surface, and the first end of the second beam is connected to the second end of the first beam;
wherein said second beam is angled upwards from the first beam;
wherein said third beam has a first end and a second end, and said first end is connected to the top surface of the first beam and the second end is connected to the top surface of the second beam;
wherein the receiving member has a first end, a second end, a top surface, two side surfaces, and an interior receiving volume;
wherein the bottom surface of the receiving member is connected to the second end of the second beam;
wherein the second pin hole is located on a side surface of the receiving volume.

5. The hitch cargo carrier assembly of claim 4 wherein the cargo carrier comprises a mounting flange, a base, vertical beams, horizontal beams, and a collar.

6. A hitch receiver extension assembly comprising:
a first beam and a second beam;
wherein the first beam has a first end, second end, and central axis and the second beam has a first end, second end, and central axis;
wherein the second beam extends from the first beam at an obtuse angle.

7. The hitch receiver extension assembly of claim 6 wherein the angle between the central axis of the first beam and the central axis of the second beam is 133 degrees.
